(19) United States
(12) Patent Application Publication
(10) Pub. No.: US 2005/0138007 A1
(43) Pub. Date: Jun. 23, 2005

(54) Document enhancement method

(75) Inventor: Einat Amitay, Kibbutz Shaar HaGolan (IL)

Correspondence Address: Stephen C. Kaufman;Intellectual Property Law Dept., IBM Corporation, P.O. Box 218, Yorktown Heights, NY, 10598, US

(73) Assignee: International Business Machines Corporation, Armonk, NY (US)

(21) Appl. No.: 10/743,158

(22) Filed: Dec. 22, 2003

(51) Int. Cl. G06F 7/00

(52) U.S. Cl. 707/3

(57) ABSTRACT

A search system includes a search engine to search through an index of documents and an index enhancer to enhance the index with at least some user queries. The index may include a listing of terms found in documents to be indexed and at least in user queries used to find said documents and a listing at least of how frequently such terms occurred in the documents and user queries.

### FIELD OF THE INVENTION

The present invention relates generally to search engines and indexing methods.

### BACKGROUND OF THE INVENTION

Search engines are known. They are part of every database and of every index. Databases typically store information from one business, in set records. Indices are an itemizing of data found in many places. For example, Google.com and Altavista periodically index the pages of the World Wide Web to create web indices.

Google.com has enhanced their search engine to look both at the words on the page and on the hyperlinks (composed by others) pointing to that page. The text that appears on the hyperlink (usually highlighted in blue) is known as “anchor text” and is stored with the page in the index.

FIG. 1, to which reference is now made, illustrates a small portion of a simplified index. Each term found in the documents or pages being indexed is listed in the first column 2. Associated with each term are the total number of occurrences of the term (column 4) and where in the document the occurrences occurred (in the title (column 6), anchor text (column 8) or text (column 10)). In each cell of columns 4, 6, 8 or 10, the document number and number of occurrences is listed. For example, the following is listed as the total number of occurrences of term A:
(doc#1, 5000), (doc#4, 6), (doc#67, 90), (doc#1220, 9) . . .
Thus, term A is found 5000 times in document 1, 6 times in document 4, 90 times in document 67 and 9 times in document 1220. All 5000 times in document 1 occur in the anchor text (column 8) while document 4's 6 times are found in two places, 4 in the text and 2 in the title.

Some indices also list where in the document each term occurs. Thus, the item may be listed as (doc#, character within document number). This maintains the structure of the original document and may form an additional column in the index. An index may also contain more elaborate references to how the term appeared in the text (e.g. bold face, emphasized, color of text, size of text, etc.). Each such reference may have its own count in the index.

As many people have discovered, finding things on “The Web” can be easy, but only if the user knows the right terms to use to do the search. The right terms are those used by the designers of the web pages. This makes finding non-specific items difficult. For example, one user went to Amazon.com to buy a music toy for a 5 year old boy, but the process took a number of searches until a desired item was found. Just typing “music toy for 5 year old boy” produced a listing of various things for and about young boys, but did not produce a suitable toy. Included in the list, however, was “Visit Our Musical Instruments Store”. When selected, a collection of children's music toys showed up. None of them were acceptable, so the selection “Other Musical Instruments” was pressed. This selection was more useful as it included “Marching Band Kit”, the desired item.

In another example, a user was looking for the “IR” (information retrieval) book. He did a search on Google for “IR book”. This produced a listing of books, but none of them were the most recent book whose full name is Modern Information Retrieval. Only by typing “modern information retrieval” was the most recent IR book retrieved.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a small portion of a simplified prior art index;

FIG. 2 is a block diagram illustration of a searching system, constructed and operative in accordance with the present invention;

FIG. 3 is a small portion of a simplified enhanced index produced by the system of FIG. 2; and

FIG. 4 is a simplified query index useful in the system of FIG. 2.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

Applicant has realized that there is a significant amount of information in user's queries about how users view the items for which they are searching. In accordance with a preferred embodiment of the present invention, the query words may be joined to the information in the index, thereby increasing the ways in which an item may be described.

For the examples in the Background, the page of “Marching Band Toy” will have the words “music toy for 5 year old boy” associated with it in the index and the book Modern Information Retrieval will have “IR book” associated therewith so that other searchers who might use those terms will see these items as part of the results of their first search.

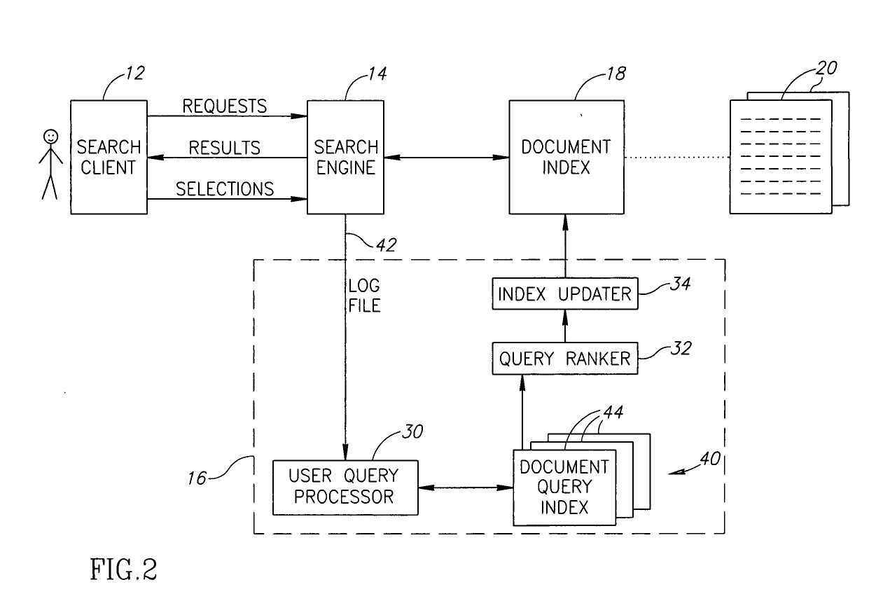

Reference is now made to FIG. 2, which illustrates a searching system 10, constructed and operative in accordance with the present invention. Searching system 10 may comprise a search client 12, a search engine 14 and an index enhancer 16.

Search client 12 and search engine 14 may be any search client and engine, such as those known in the art, which operates on an index 18 of a multiplicity of documents 20. As is known, search client 12 may send search requests to search engine 14 which may, in turn, provide search results in the form of ranked listings of documents 20 that match the search request. Search client 12 may then select a document from the list or may request another search.

The indexed documents might be a single page, a whole web site, a series of linked pages not necessarily composed by a single person or stored under the same domain, or a single page with all the portions of the pages that point to it (i.e. the anchor text that appears on links pointing to the page, or even the text surrounding the anchor text and assumed to be referring to the pointed page). Each such reference may also be described in the index (e.g. how many times a term appeared as anchor text).

Like any index, index 18 may store various information about each term, such as its position in the document, its function (e.g. appeared in the title, in a sub-title, as body text, as anchor text, etc.), whether it was emphasized (capitalization, bold face, italics, color, etc.), its frequency of occurrence, the distances between occurrences, etc.

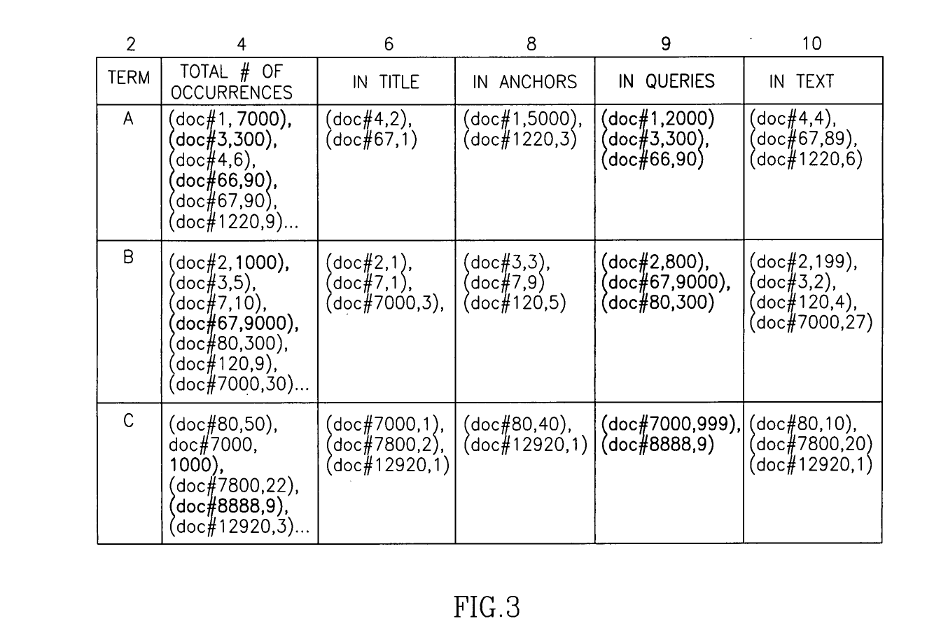

In accordance with a preferred embodiment of the present invention, index enhancer 16 may add terms and/or other details to index 18 or to any of documents 20 based on users' queries submitted to search engine 14. Index enhancer 16 may add the terms to the documents themselves (as metadata), or to their representation in index 18, as discussed hereinbelow with respect to FIG. 3, or in any other way.

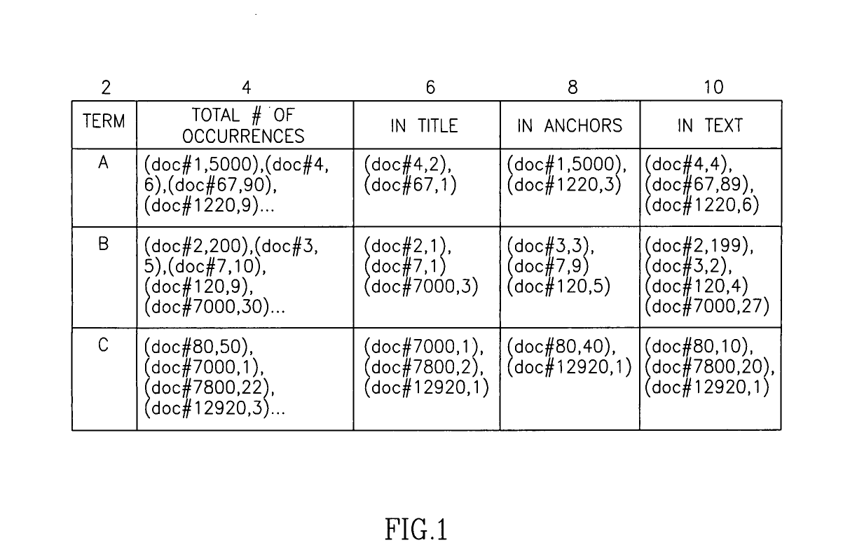

For example, FIG. 3, to which reference is now briefly made, illustrates an exemplary enhanced version of the exemplary partial index of FIG. 1, where the new information is marked therein with bolding. The enhanced index may have the same columns 2, 4, 6, 8 and 10 as the prior art version. It additionally has a column 9, which stores query information. The information in the title, anchors and text columns 6, 8 and 10 has not changed. What does change is the information in total number of occurrences column 4.

For example, document 1 now has 7000 occurrences of term A, since 2000 have been added from users' queries. Document 67, which previously only had term A, now also has 9000 occurrences of term B, all of them in queries, as listed in query column 9. Multiple word queries are either stored as full phrases or proximity information may be stored in a manner similar to that for the document text or for the anchor text associated with it.

When search engine 14 may search the enhanced index 18, it may use the enhanced information to output different search results based on the new query terms associated with the indexed documents. As a result, if someone searches the enhanced index for “toy for 5 year old” as discussed in the Background, search engine 14 may return a link to the Marching Band Set. Similarly, if someone searches the enhanced index for “IR book”, search engine 14 may return links to all books, including the most recent one.

Index enhancer 16 may comprise a user query processor 30, a query ranker 32 and an index enhancer 34. User query processor 30 may analyze a log file, produced by search engine 14, of user's queries and results. Some search engines also log user's final selections and user query processor 30 may analyze these as well.

User query processor 30 may add user's queries to a document query index 40, which may associate each query with the documents 20 generated by it. It may also associate all the queries in a multi-search session with all of the documents generated, or with only the top ranked results of each query. Alternatively, if the system is able to tell which documents the user followed as a result of a search, then processor 30 may associate the query only with the documents viewed or clicked upon. A session may be defined in any suitable way, such as within a predefined length of time, or during a log-in period.

In a further embodiment, if the user browsed for information between the queries, rather than using the results of the query, query processor 30 may associate the queries with the browsed documents as well. This may be possible only if the browsed documents may be found in the original index and may be available to have queries added to them

Extra weight may be given to the document selected at the end of the search session, as that is usually the desired item. This document may be associated with each of the queries of the search or just the initial search terms, as the initial search terms are usually the natural language terminology of the user. Alternatively or in addition, different weights may be assigned to different queries depending on their timing with relation to the user's initial query.

It will be appreciated that the query term may be in any language, irrespective of the language of the original document. For example, if the user queries for something in German and finds nothing and then moves into English and finds something, then the German word may also be added associated with the English documents.

In an alternative embodiment, only the selected document and the initial search term may be stored, as the selection may be the answer to the user's initial query. Further alternatively, the user may be asked to indicate which search terms are relevant to his final selection(s).

User query processor 30 may operate in conjunction with search engine 14, and thus, it may receive the search requests, results and selection in real- or semi-real-time. Alternatively, and as shown in FIG. 2, user query processor 30 may operate on a log file 42 generated by search engine 14.

Document query index 40 may be organized in any suitable manner. One exemplary manner may have one query document 44 per indexed document 20, where each query document 44 may list the queries and how many times that particular query was used in log file 42. For real- or semi-real-time operation, the frequency of the query may be continually updated. Similarly, when multiple log files 42 may be reviewed, the frequency of queries may be updated.

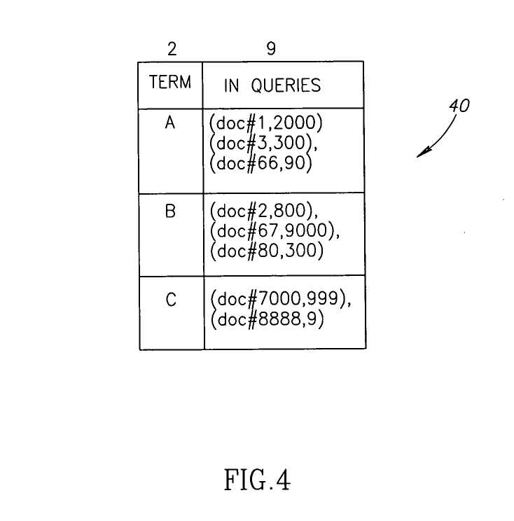

In another embodiment, shown in FIG. 4 to which reference is now briefly made, query index 40 may list the same terms as in document index 18 and may list the frequency of occurrence of the terms in the queries associated with the documents.

At an appropriate time, it may be desired to enhance document index 18. Query ranker 32 may review query index 40 to determine which queries to add to document index 18. Any suitable heuristic may be employed. A straightforward heuristic may be to add all queries and to weight them by their frequency of use. Other heuristics may involve selecting only those with a significant frequency of use. Still other heuristics may involve removing any ‘outdated’ queries. This latter heuristic may require that user query processor 30 stores a time-stamp associated with each query in index 40. Another heuristic may involve deciding which term is “mature” enough to be fully and permanently associated with a document 20. Another heuristic may involve assigning weights to terms so that they appear in index 18 as ‘not sure about’ and then attach this weight to the term for the ranking calculations performed by search engine 14.

Index enhancer 34 may be similar to known index updaters in that it may review an index and change the information therein. Enhancer 34 may take the ranked queries produced by query ranker 32 and may associate them with their associated document 20 in index 18. Index enhancer 34 may add the queries to the associated anchor text 22, to the associated document 20, to additional text section 24, as query column 9 or in any other suitable manner. If appropriate, index enhancer 34 may also review the time-stamps of previously added queries, updating any time-stamps for common queries and removing any queries whose time-stamps are ‘old’, where old may have any suitable definition.

Index enhancer 34 may update the entire query list associated with each document 20, both by adding queries and by updating the frequency of use and time-stamps of existing queries. Index enhancer 34 may rank the queries according to any suitable heuristic. One heuristic may be frequency of use. Another may be according to the time-stamps discussed hereinabove.

Once index enhancer 34 has finished, search engine 14 may search the enhanced index 18 with new queries.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A search system comprising:
a search engine to search through an index of documents; and
an index enhancer to enhance said index with at least some user queries.

2. The system according to claim 1 and wherein said index enhancer comprises a query processor to associate queries with documents retrieved by said search engine.

3. The system according to claim 2 and wherein said query processor comprises means to determine which of said retrieved documents to associate with said queries and means to determine which queries to associate with said retrieved documents.

4. The system according to claim 3 and wherein said associated queries comprise a portion of the queries used in a session.

5. The system according to claim 3 and wherein said associated queries comprise the first query of a session.

6. The system according to claim 3 and wherein said determined retrieved document comprises the document selected by said user.

7. The system according to claim 3 and wherein said determined retrieved document comprises the document browsed to by said user as a result of a query.

8. The system according to claim 3 and wherein said determined retrieved documents comprise the higher ranked documents produced from a query.

9. The system according to claim 2 and wherein said user queries are in a language other than the language of a selected document.

10. The system according to claim 1 and wherein said index enhancer comprises a query ranker to rank queries associated to documents.

11. The system according to claim 10 and wherein said query ranker comprises means to rank said queries according to frequency of usage.

12. The system according to claim 10 and wherein said query ranker comprises means to rank said queries according to time of usage.

13. The system according to claim 10 and wherein said index enhancer comprises an index updater to enhance said index with at least some of said ranked queries.

14. The system according to claim 13 and wherein said index updater comprises means to filter out lowly ranked queries.

15. An index comprising:
a listing of terms found in documents to be indexed and at least in user queries used to find said documents; and
a listing at least of how frequently such terms occurred in said documents and user queries.

16. The index according to claim 15 and wherein said user queries comprise a portion of the queries used in a session to find a selected document.

17. The index according to claim 15 and wherein said user queries comprise the first query of a session to find a selected document.

18. The index according to claim 15 and wherein a document associated with a query comprises the document selected by said user.

19. The index according to claim 15 and wherein a document associated with a query comprises the document browsed to by said user as a result of a query.

20. The index according to claim 15 and wherein documents associated with a query comprise the higher ranked documents produced from a query.

21. The index according to claim 15 and wherein said user queries are in a language other than the language of a selected document.

22. A query index comprising:
a listing of terms found in user queries; and
a listing of documents said terms were used to retrieve.

23. The index according to claim 22 and wherein said user queries comprise a portion of the queries used in a session to find a selected document.

24. The index according to claim 22 and wherein said user queries comprise the first query of a session to find a selected document.

25. The index according to claim 22 and wherein a document associated with a query comprises the document selected by said user.

26. The index according to claim 22 and wherein a document associated with a query comprises the document browsed to by said user as a result of a query.

27. The index according to claim 22 and wherein documents associated with a query comprise the higher ranked documents produced from a query.

28. The index according to claim 22 and wherein said user queries are in a language other than the language of a selected document.

29. A search system comprising:
a search client to issue user queries; and
a search engine to search through an index of documents, wherein said index indexes at least an original text and at least one query describing something about said original text.

30. The system according to claim 29 and wherein said index comprises:
a listing of terms found in documents to be indexed and at least in user queries used to find said documents; and
a listing at least of how frequently such terms occurred in said documents and user queries.

31. The index according to claim 30 and wherein said user queries comprise a portion of the queries used in a session to find a selected document.

32. The index according to claim 30 and wherein said user queries comprise the first query of a session to find a selected document.

33. The index according to claim 30 and wherein a document associated with a query comprises the document selected by said user.

34. The index according to claim 30 and wherein a document associated with a query comprises the document browsed to by said user as a result of a query.

35. The index according to claim 30 and wherein documents associated with a query comprise the higher ranked documents produced from a query.

36. The index according to claim 30 and wherein said user queries are in a language other than the language of a selected document.

37. A method comprising:
enhancing an index of documents with at least some user queries.

38. The method according to claim 37 and wherein said enhancing comprises associating queries with documents retrieved by a search engine.

39. The method according to claim 38 and wherein said enhancing comprises determining which of said retrieved documents to associate with said queries and determining which queries to associate with said retrieved documents.

40. The method according to claim 38 and wherein said enhancing comprises listing a term in a query and the number of times that term is associated with a document.

41. The method according to claim 38 and wherein said enhancing comprises ranking queries associated to documents.

42. The method according to claim 41 and wherein said ranking comprises ranking said queries according to frequency of usage.

43. The method according to claim 41 and wherein said ranking comprises ranking said queries according to time of usage.

44. The method according to claim 41 and wherein said enhancing comprises updating said index with at least some of said ranked queries.

45. The method according to claim 44 and wherein said updating comprises filtering out lowly ranked queries.

46. A computer product readable by a machine, tangibly embodying a program of instructions executable by the machine to perform method steps for enhancing an index, said method steps comprising:
enhancing an index of documents with at least some user queries.

47. The product according to claim 46 and wherein said enhancing comprises associating queries with documents retrieved by a search engine.

48. The product according to claim 47 and wherein said enhancing comprises determining which of said retrieved documents to associate with said queries and determining which queries to associate with said retrieved documents.

49. The product according to claim 47 and wherein said enhancing comprises listing a term in a query and its location in the query.

50. The product according to claim 47 and wherein said enhancing comprises listing a term in a query and the number of times that term is associated with a document.

51. The product according to claim 41 and wherein said enhancing comprises ranking queries associated to documents.

52. The product according to claim 51 and wherein said ranking comprises ranking said queries according to frequency of usage.

53. The product according to claim 51 and wherein said ranking comprises ranking said queries according to time of usage.

54. The product according to claim 51 and wherein said enhancing comprises updating said index with at least some of said ranked queries.

55. The product according to claim 54 and wherein said updating comprises filtering out lowly ranked queries.
